(19) United States
(12) Patent Application Publication
(10) Pub. No.: US 2026/0122022 A1
(43) Pub. Date: Apr. 30, 2026

(54) Maintaining Relevant Communication History In Association With An Entity For Concurrent Display Of The Communication History And The Entity

(71) Applicant: Oracle International Corporation, Redwood Shores, CA (US)

(72) Inventor: Jennifer Darmour, Seattle, WA (US)

(73) Assignee: Oracle International Corporation, Redwood Shores, CA (US)

(21) Appl. No.: 19/296,451

(22) Filed: Aug. 11, 2025

Related U.S. Application Data
(60) Provisional application No. 63/712,067, filed on Oct. 25, 2024.

(51) Int. Cl. H04L 51/216; G06F 40/30

(52) U.S. Cl. CPC H04L 51/216; G06F 40/30

(57) ABSTRACT

Techniques for concurrently presenting a data object and messages related to the data object are disclosed. The system accesses a data object comprising a set of content. The system extracts and displays the set of content from the data object in a Graphical User Interface (GUI). The system determines that a set of messages is stored in association with the data object. The system presents the set of messages concurrently in the GUI with the set of content based on (a) the set of content from the data object being displayed and (b) the set of messages being stored in association with the data object. When presenting a different set of content, the system presents another set of messages associated with the different set of content. The system maps a new message to a data object when the new message is associated with the data object.

### BENEFIT CLAIMS; RELATED APPLICATIONS; INCORPORATION BY REFERENCE

This application claims the benefit of U.S. Provisional Patent Application 63/712,067, filed Oct. 25, 2024, which is hereby incorporated by reference.

### TECHNICAL FIELD

The present disclosure relates to storing a message history in association with an application data object. In particular, the present disclosure relates to providing access to the message history via an interface for the application data object and to the application data object via an interface for the message history.

### BACKGROUND

Users exchange messages during the course of a process workflow, such as while scheduling an appointment or collaborating on a project. The messages, related to a specific process transaction, may provide valuable context to the users.

The approaches described in this section are approaches that could be pursued but not necessarily approaches that have been previously conceived or pursued. Therefore, unless otherwise indicated, one should assume that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for presenting messages concurrently with associated content in accordance with one or more embodiments;

FIGS. 3, 4A, 4B, 5, and 6 illustrate various examples of GUI windows in accordance with one or more embodiments; and

FIG. 7 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1 GENERAL OVERVIEW
2. COMMUNICATION HISTORY MAPPING ARCHITECTURE
3 PRESENTING MESSAGES CONCURRENTLY WITH ASSOCIATED CONTENT
4. EXAMPLE EMBODIMENT
5. COMPUTER NETWORKS AND CLOUD NETWORKS
6. HARDWARE OVERVIEW
7. PRACTICAL APPLICATIONS, ADVANTAGES, AND IMPROVEMENTS
8. MISCELLANEOUS; EXTENSIONS

### 1. GENERAL OVERVIEW

One or more embodiments detect and present communication associated with a data object concurrently with the presentation of the data object. The communication, including current and historical messages, provides context for the data object and enables rapid access to discussions relevant to the data object. In an example, the system accesses a data object that includes a set of content. The system extracts and displays the set of content from the data object in a Graphical User Interface (GUI). The system determines that a set of messages is stored in association with the data object. The set of messages may be stored in an entirely different data structure with no relationship to the data object, other than an explicit association between the messages and the data object. The system presents the set of messages concurrently in the GUI with the set of content. When presenting a different set of content, the system presents a different set of messages associated with the different set of content.

In an embodiment, the system maps communications to data objects for future reference. The system monitors conversations to detect messages that may be relevant to any of a set of data objects. In response to determining that a message is relevant to a particular data object, the system extracts the message from the dataset corresponding to the communication. The system then stores the message in association with the data object. Alternatively, the system stores a pointer in association with the data object that points to the message within the dataset or points to another data object that includes the message.

In an embodiment, the system removes an association between stored communication and a data object in response to determining that the stored communication is no longer relevant to the data object. In an example, a data object corresponds to a doctor's appointment. The communication stored in association with the data object includes messages exchanged between the patient and a receptionist that sets up doctors' appointments. The messages include a discussion of the patient's availability for the appointment as well as availability for rescheduling the appointment if needed. Subsequent to completion of the doctor's appointment, the system determines that the patient's availability for the appointment is no longer relevant to the appointment since the appointment has already occurred. In response to determining that the patient's availability is no longer relevant to the appointment, the system removes the association of the messages with the appointment. Removing the association may include simply delinking the data object from the messages such that a display of the data object no longer results in the concurrent display of the messages. Alternatively, or additionally, the system may delete the messages such that the messages are no longer stored or accessible.

One or more embodiments described in this Specification and/or recited in the claims may not be included in this General Overview section.

### 2. COMMUNICATION HISTORY MAPPING ARCHITECTURE

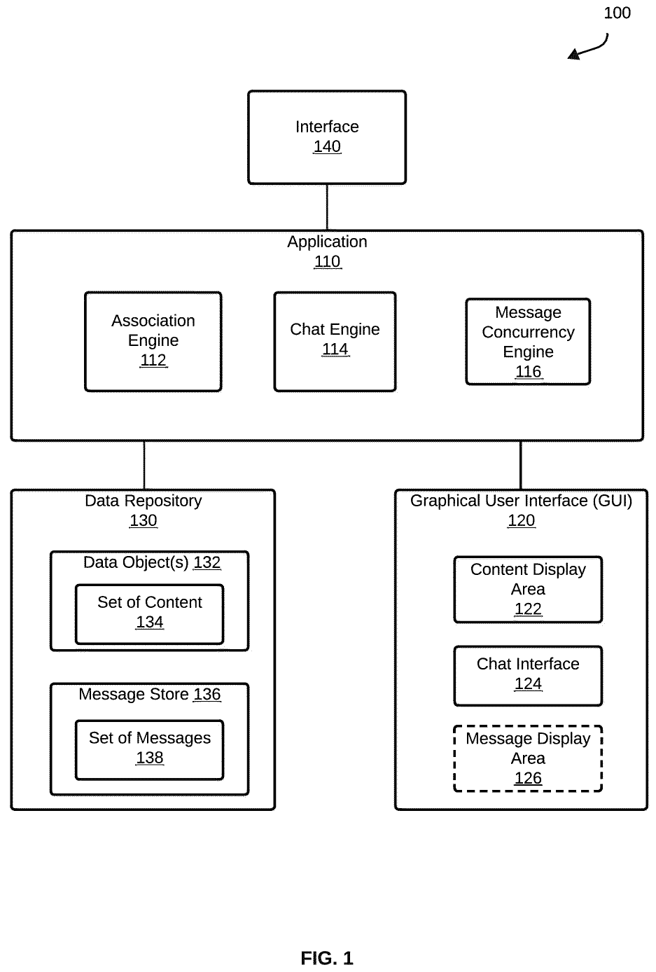

FIG. 1 illustrates a system 100 in accordance with one or more embodiments. As illustrated in FIG. 1, system 100 includes an application 110, a graphical user interface (GUI) 120, a data repository 130, and an interface 140. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

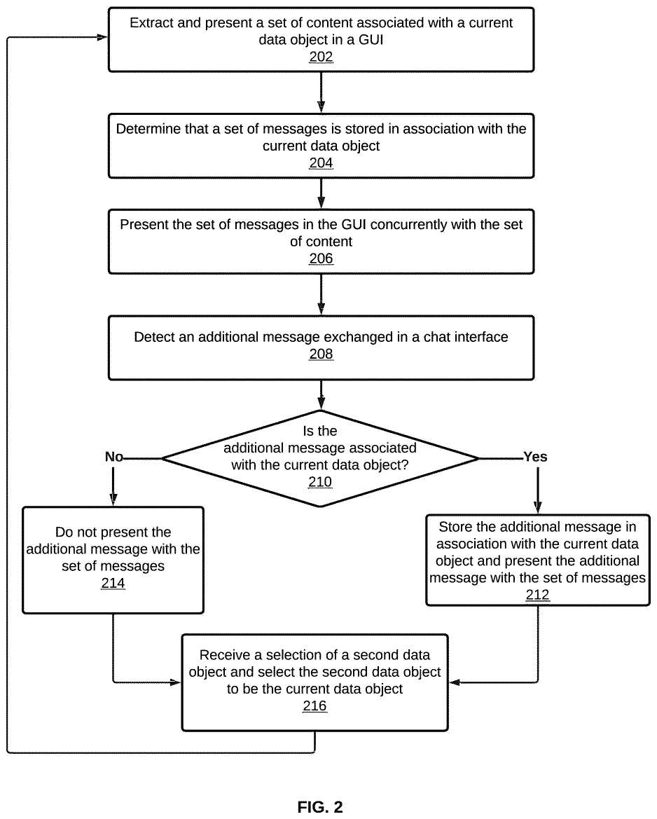

In one or more embodiments, application 110 refers to hardware and/or software configured to perform operations described herein for presenting messages concurrently with an application entity having associated content. Examples of operations for presenting messages concurrently with associated content are described below with reference to FIG. 2.

The application 110 may generally use, create, and/or store data objects 132 related to the function of the application. A data object 132 may include one or more files or database records related to a particular topic. A data object 132 may include a data structure or class object. A data object 132 may include a sequence of steps or operations interacting with data, such as a workflow or a process. For example, if the application is a medical practice management application, the application may create appointment data objects, medical record data objects, personnel data objects, and workflows for scheduling an appointment or ordering testing. If the application is a collaboration application, the application may maintain change-history data objects for documents, and scheduling-workflow data objects. The application 110 may enable users to send and receive communications, such as chat messages, electronic mail messages, and text messages. The application 110 may store the communications in a message store 136.

The application 110 may include one or more functional components, such as an association engine 112, a chat engine 114, and a message concurrency engine 116. More, fewer, or different functional components may be used. The association engine 112 may create, maintain, and remove associations or mappings between messages in a set of messages 138 and a data object 132. For example, the association engine 112 may map a message to a data object based on a topic identified for a set of content 134 that is associated with a data object 132. In another example, the association engine 112 may map a message to a data object based on a temporal relationship between a displayed set of content and the receipt of the message. The association engine 112 may map a message to one or more data objects when the message is received. The association engine 112 may map a message to one or more data objects later, after the message is received.

The association engine 112 may monitor messages exchanged in the application 110. When the association engine 112 determines that a message is relevant to one or more data objects, the association engine 112 may map the message to the one or more data objects even when no data object is currently presented or the relevant data object is not being presented. The association engine 112 may determine that a message is no longer relevant to a data object and remove the association between the message and the data object.

The chat engine 114 may operate to provide a chat function. For example, the chat engine 114 may provide a chat interface 124 within the GUI 120 that permits a user to compose, send, receive, and read messages exchanged with another entity. The chat engine 114 may deliver a message to a recipient, such as another user or to an automated chat agent (e.g., a chatbot). The chat engine 114 may store messages in the message store 136.

Although shown as a component of application 110, the chat engine 114 may be a stand-alone chat application or a component of an operating system. When not a component of application 110, the chat engine 114 may allow application 110 to access the messages in the message store 136.

The message concurrency engine 116 may monitor content presented in the GUI 120 and identify messages associated with the content. The message concurrency engine 116 may display the associated messages while the content is presented. When the presented content changes, the message concurrency engine 116 may change the display to present a different set of messages associated with the new content.

In one or more embodiments, GUI 120 refers to hardware and/or software configured to present application components to a user on a display. The GUI may present static information and interactive elements. In one or more embodiments, GUI 120 has a content display area 122. GUI 120 may present a set of content 134 from a data object 132 in the content display area 122. In one or more embodiments, GUI 120 has a chat interface 124 and an optional message display area 126. The GUI 120 may present a set of messages 138 in the chat interface 124 to allow a user to continue a conversation related to the data object. The set of messages 138 may include messages exchanged in a current chat exchange and/or messages that are mapped to the set of content 134 from the data object 132. The system may, alternatively, present messages received and stored at an earlier time in the message display area 126 to provide historical context for the currently presented data object while presenting a currently ongoing chat conversation in the chat interface 124.

In one or more embodiments, a data repository 130 is any type of storage unit and/or device (e.g., a file system, database, collection of tables, or any other storage mechanism) for storing data. Furthermore, a data repository 130 may include multiple different storage units and/or devices. The multiple different storage units and/or devices may or may not be of the same type or located at the same physical site. Furthermore, a data repository 130 may be implemented or executed on the same computing system as application 110. Additionally, or alternatively, a data repository 104 may be implemented or executed on a computing system separate from application 110. The data repository 104 may be communicatively coupled to application 110 via a direct connection or via a network.

Information describing the data objects 132 and messages store 136 may be implemented across any of components within the system 100. However, this information is illustrated within the data repository 130 for purposes of clarity and explanation.

In an embodiment, system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 140 refers to hardware and/or software configured to facilitate communications between a user and the application 110. Interface 140 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 140 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 140 is specified in one or more other languages, such as Java, C, or C++.

### 3. PRESENTING MESSAGES CONCURRENTLY WITH ASSOCIATED CONTENT

FIG. 2 illustrates an example set of operations for presenting messages concurrently with associated content in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system extracts and presents a set of content associated with a current data object in a GUI (Operation 202). The system may respond to a user selection of a data object, such as a command to open a file, start a scheduling process, or search a database. The system may present content, such as text and interactive elements relevant to a step in a workflow or process data object. The system may present content such as options for scheduling an appointment. The system may present content about earlier data objects for the user such as an appointment history.

In an embodiment, the system determines that a set of messages is stored in association with the current data object (Operation 204). The system may determine one or messages mapped the current data object. For example, the system may access a relationship field or a link from the set of content and/or the current data object to a set of messages. Additionally, or alternatively, the system may determine the set of messages directly from a field of the current data object. The system may determine if there is a set of messages in the message store that are relevant to a newly created data object and may associate the set of messages with the newly created data object.

In an embodiment, the system presents the set of messages in the GUI concurrently with the set of content (Operation 206). The system may present some or all of the messages in the set of messages in a chat interface or message display area separately from the presented set of content, so the user can view both the content and the set of messages simultaneously. If the set of messages is too large to present completely in the chat interface or message display area, the system may provide a scroll bar or other navigational aid. Alternatively, the system may select a subset of the set of messages to present, e.g., the five most recent messages, and may provide an interface element to allow the user to request another portion of the set of messages.

In an embodiment, the system presents a shortcut to the set of messages when the data object is being presented or accessed. The system may present a shortcut adjacent to an interface element that represents the data object. When the system receives user input selecting the shortcut, the system may present the set of messages. This allows the user to access the related messages at a time of the user's choosing so as not to interfere with the user's interactions with the presented set of content. On devices with limited display area, such as a mobile device, this preserves the display area for the content until the user chooses to access the set of messages.

In an embodiment, the system detects an additional message exchanged in a chat interface (Operation 208). The system may detect that a user of the system, or a chatbot, has composed and sent a message using the chat interface. The system may present the additional message in the chat interface for the sender. The system may temporarily refrain from presenting the additional message in the recipient's chat interface while performing the next operation.

In an embodiment, the system determines if the additional message is associated with the current data object (Operation 210). The system may determine that the additional message is associated with the current data object based on concurrent presentation of set of content from the data object and the additional messages. Specifically, the system determines that the additional message is associated with the current data object based on the additional message being exchanged while the current data object is presented.

The system may execute a semantic analysis of the additional message to identify one or more topics or keywords in the additional message. The system may determine a topic associated with the current data object. If the topic or keyword of the additional message and the topic of the current data object meet similarity criteria, the system may determine that the additional message is associated with the current data object. For example, an appointment scheduling data object may be associated with one or more topics, such as a purpose for the appointment, a type of appointment, and participants in the appointment. If the additional message includes words or phrases associated with the purpose, type, or participants, then the system may determine that the additional message is associated with the current data object.

The system may determine that the additional message is associated with the current data object based on user interaction data. If a user interacts with the current data object and engages in a chat conversation at the same time or within a defined time period of an interaction with the current data object, the system may determine that the additional message is associated with the current data object.

In an embodiment, when the additional message is associated with the current data object, the system maps the additional message to the current data object by storing the additional message in association with the current data object (Operation 212). The system presents the additional message with the set of messages in the GUI. The system may store a relationship or link between the additional message and the current data object, e.g., to a workflow, or to interface elements, dashboards, objects, etc. associated with the workflow.

For example, the current data object may have an identifier in the system. The system may add the identifier of the current data object to a mapping store in association with an identifier of the message. The system may add the identifier of the message to metadata associated with the current data object. Additionally, or alternatively, the system may store the additional message in a data field of the current data object, or, for example, in a dataset used for executing the workflow.

In some cases, the additional message may include a group of messages, for example, as generated during a real-time chat exchange. The system may use semantic analysis on the group of messages to determine a subset of messages that relate to a topic associated with the current data object. The system may then map the subset of messages to the current data object.

The system may determine that the additional message is associated with additional data objects and may map the additional message to the additional data objects as well as to the current data object. For example, a message may be associated with a scheduling data object and with a billing data object.

The system may present the additional message within a chat interface if the other participant in the chat exchange is available to continue an exchange of messages, e.g., logged in to the system. If the other participant is not available to continue an exchange of messages, the system may present the additional message as part of a static display of the set of messages.

In an embodiment, when the additional message is not associated with the current data object, the system does not present the additional message with the set of messages in the GUI (Operation 214). In an embodiment, the system maps communications to data objects for future reference even if the communications are not relevant to a currently presented data object. For example, the system may monitor messages in chat conversations and identify messages that are relevant to one or more other data objects. In response to determining that a message is relevant to a particular data object, the system may extract the message from a dataset corresponding to the communication. The system may store the message in association with the data object. Alternatively, the system stores a pointer in association with the data object that points to the message within the dataset or points to another data object that includes the message.

The system may determine that the additional message is associated with one or more other data objects and store the additional message in association with the one or more other data objects. The system may present an interface element to indicate that a new message has been received, allowing the user to navigate to the additional message away from the set of messages currently presented.

In an embodiment, the system receives a selection of a second data object and selects the second data object to be the current data object (Operation 216). The system may repeat the set of operations, returning to Operation 202. Consequently, the set of messages presented in the GUI may be changed according to the second data object. For example, if the user chooses to view a test result or an invoice, the system may replace the previous set of presented messages with a set of messages associated with the test result or invoice. When there are no messages associated with presented content, the system may remove the previous set of presented messages from the GUI.

In an embodiment, the system removes an association between stored communication and a data object in response to determining that the stored communication is no longer relevant to the data object. The system may periodically access a stored data object and examine messages associated with the data object to assess if a message is still relevant to the data object. Additionally, or alternatively, the system may access stored messages and examine data objects associated with a message to assess if the message is still relevant to the data object. The system may determine that a message is no longer relevant based on a state of the associated data object, for example, if the data object is in a completed or archived state. The system may determine that a message is no longer relevant based on the existence or location of the associated data object, for example, if the data object has been deleted or moved to another location in a file system.

In an example, a data object corresponds to a doctor's appointment. The communication stored in association with the data object includes messages exchanged between the patient and a receptionist that sets up doctors' appointments. The messages include a discussion of the patient's availability for the appointment as well as availability for rescheduling the appointment if needed. Subsequent to completion of the doctor's appointment, the system determines that the patient's availability for the appointment is no longer relevant to the appointment since the appointment has already occurred. In response to determining that the patient's availability is no longer relevant to the appointment, the system removes the association of the messages with the appointment data object. Removing the association may include simply delinking the data object from the messages such that a display of the data object no longer results in the concurrent display of the messages. Alternatively, or additionally, the system may delete the messages such that the messages are no longer stored or accessible.

### 4. EXAMPLE EMBODIMENT

In an example, the system maps a set of messages between a patient and a doctor to an appointment data object. The set of messages is maintained in association with the appointment data object as the appointment data object changes from a pre-scheduled stage to a scheduling stage or a completed stage. The messages exchanged throughout the time period corresponding to the changes in the appointment data object may be stored in association with the appointment data object. The system may present a shortcut on a patient dashboard or a doctor dashboard adjacent to the appointment data object. This allows for quick access to the relevant messages by the patient or the doctor.

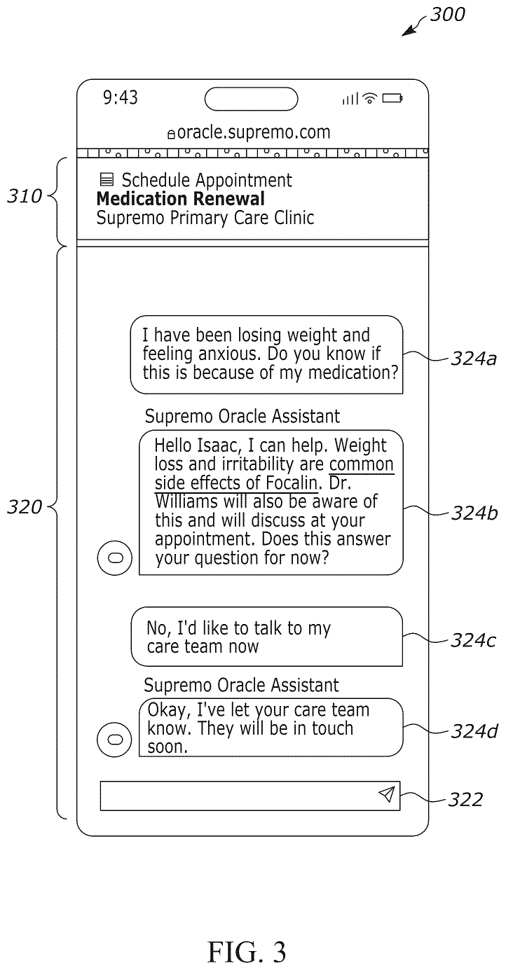

FIG. 3 illustrates an example of a GUI window 300 showing a content display area 310 and a chat conversation in a chat interface 320. Content display area 310 shows a representation of an appointment data object in a scheduling stage. The chat conversation includes a set of messages 324, with messages 324a and 324c being user-generated messages and messages 324b and 324d being system-generated messages. The user can generate additional messages in the chat input field 322. The set of messages 324 in the chat conversation are related to a scheduling stage of the appointment data object. The system stores the messages 324 in association with the appointment data object as part of a message history for the appointment data object. Additionally, or alternatively, the system may store a reference to a stored message history in association with the appointment data object.

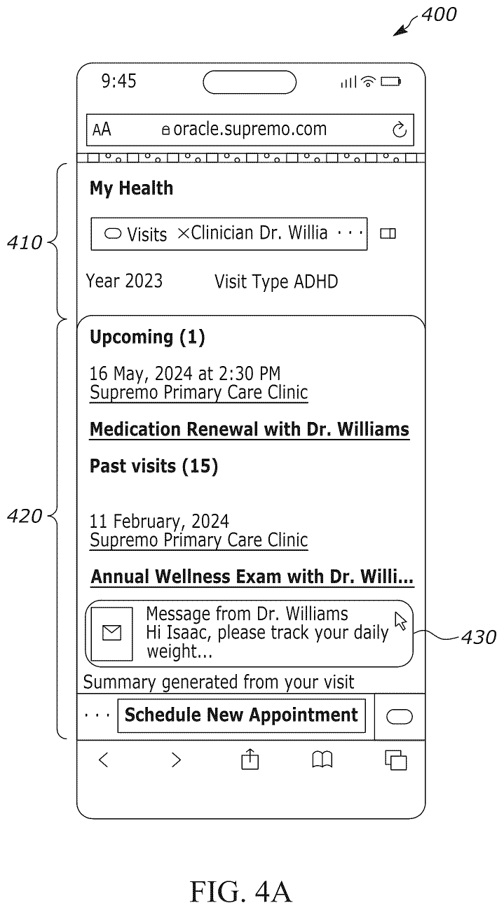

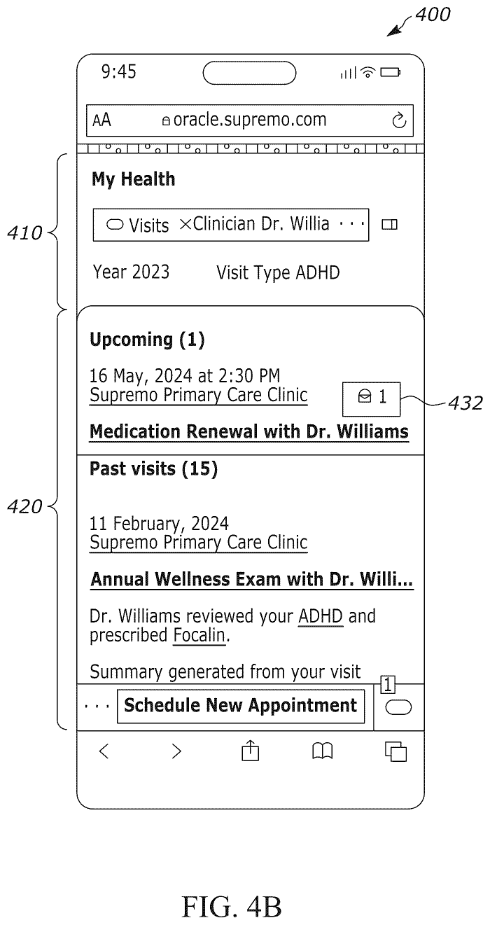

FIG. 4A illustrates an example of a GUI window 400 showing a content display area 410 and a content display area 420. The system may present the GUI window 400 after the user selects the content display area 310 in the GUI 300 show in FIG. 3. The system displays information relevant to an appointment data object in the content display area 410, for example, selections made by the user to filter available appointments. In the illustrated example, the user has selected the clinician “Dr. Williams”. The system may provide interface elements within content display area 410 that allow the user to change one or more selected filters and filter values.

The system displays information relevant to the appointment data object in the content display area 420, for example, an available appointment that meets the filter criteria from the content display area 410. The system may also display information about previously scheduled future appointment data objects and/or appointment data objects for appointments that took place in the past.

While the user is viewing and interacting with one or more of the content display areas in the GUI window 400, a message arrives for the user. The system presents a message overlay frame 430 that indicates the message sender and a portion of the body of the message. The message overlay frame 430 may temporarily appear over a portion of the content display area 420 or the content display area 410 to alert the user to the message before the system removes the overlay frame.

In an embodiment, the system may determine that the message is related to the appointment data object and/or to a chat conversation related to the scheduling stage of the appointment data object. For example, the message shown is a response to the chat message 324d from FIG. 3. If a message arrives for the user that is not related to the current appointment data object, for example, a message about a bill or invoice for a previous appointment, the system may not show a message overlay frame for the unrelated message while the user is viewing a content display area about the unrelated appointment data object.

In FIG. 4B, the system has removed the overlay frame 430 and included a message indication icon 432 in content display area 420, near the information about the current appointment scheduling data object, indicating that the message is attached to the appointment data object. The user can select the message indication icon 432 to open a messaging interface.

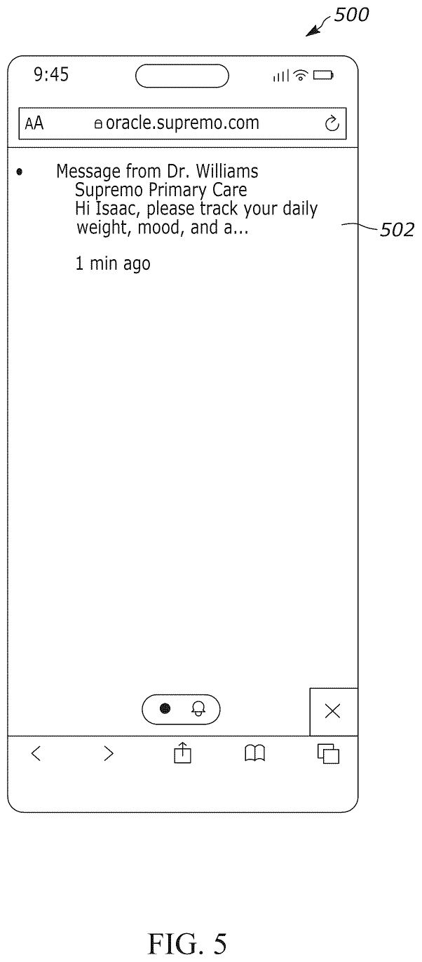

FIG. 5 illustrates an example of a messaging interface 500. The user can access the messaging interface 500 by selecting a message overlay frame or by selecting a message indication icon. The messaging interface 500 shows the most recently received message 502. The messaging interface 500 may also show prior messages and/or chat conversations that are associated with the appointment scheduling data object.

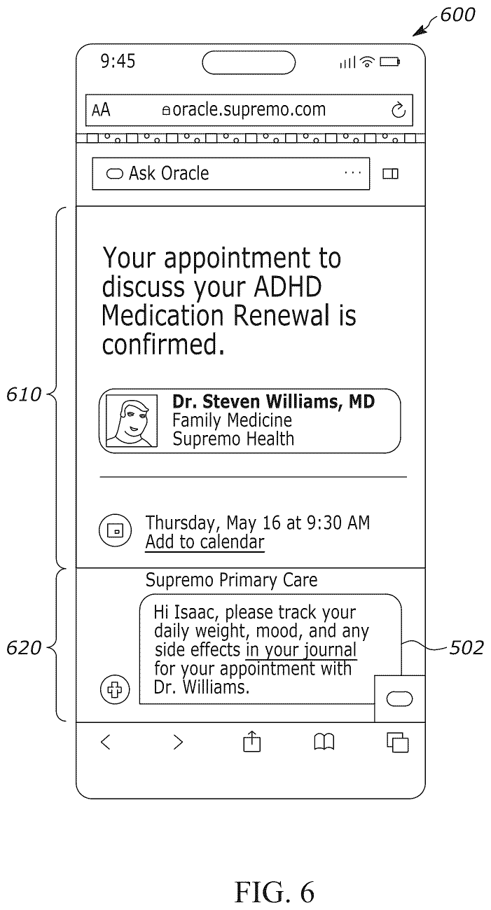

FIG. 6 illustrates a GUI window 600 for an appointment data object that is scheduled, i.e., after a scheduling stage is complete. The GUI window 600 includes a content display area 610 that shows the set of content associated with the appointment data object, e.g., the scheduled appointment information. The GUI window 600 also includes a message frame 620 that shows the latest message 502 from the message history related to the appointment data object. The user can access the messages in the message history by selecting the message frame 620. The message history associated with the appointment data object includes messages exchanged during the different stages of the appointment data object's creation: scheduling, scheduled, and completed.

### 5. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 6. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

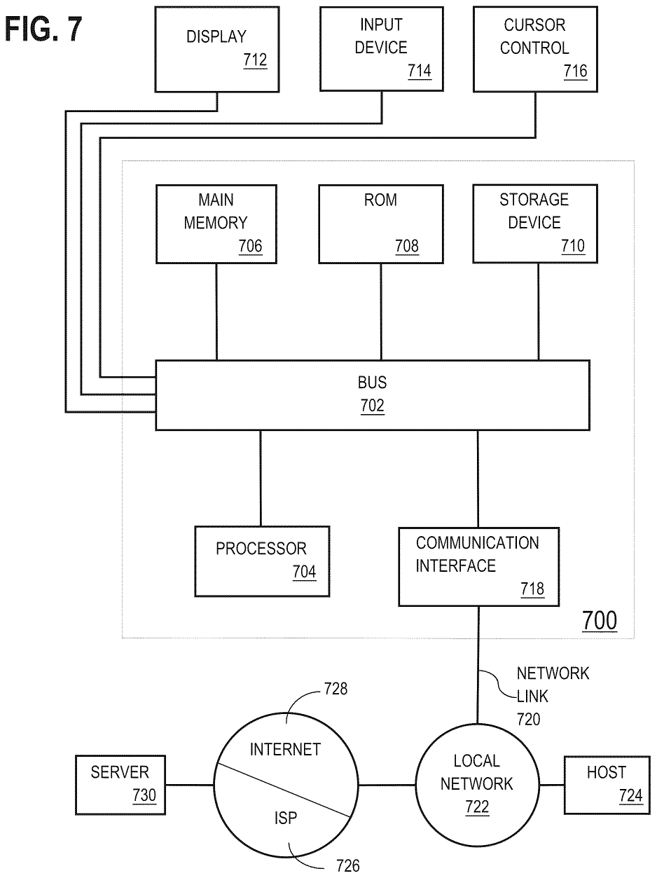

For example, FIG. 7 is a block diagram that illustrates a computer system 700 upon which an embodiment of the disclosure may be implemented. Computer system 700 includes a bus 702 or other communication mechanism for communicating information, and a hardware processor 704 coupled with bus 702 for processing information. Hardware processor 704 may be, for example, a general-purpose microprocessor.

Computer system 700 also includes a main memory 706, such as a random-access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read-only memory (ROM) 708 or other static storage device coupled to bus 702 for storing static information and instructions for processor 704. A storage device 710, such as a magnetic disk, optical disk, or a Solid-State Drive (SSD) is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into the remote computer's dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as the code is received, and/or stored in storage device 710, or other non-volatile storage for later execution.

### 7. PRACTICAL APPLICATIONS, ADVANTAGES, AND IMPROVEMENTS

One or more embodiments provide readily accessible messaging context to users of an application while interacting with the application. The system identifies and presents stored messages associated with a current data object from the application concurrently with a display of the current data object, while leaving out messages that are not relevant to the current data object. The user need not scroll or search through past message exchanges to identify the messages exchanged during a previous interaction with the data object or otherwise associated with the current data object. The system automatically associates new messages with one or more existing data objects.

### 8. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
accessing a first data object comprising a first set of content;
extracting and displaying the first set of content from the first data object in a Graphical User Interface (GUI);
determining that a set of messages is stored in association with the first data object; and
based on (a) the first set of content from the first data object being displayed and (b) the set of messages being stored in association with the first data object:
presenting the set of messages concurrently with the first set of content from the first data object in the GUI;
wherein the method is performed by at least one device including a hardware processor.

2. The method of claim 1, further comprising:
prior to extracting and displaying the first set of content from the first data object:
detecting the set of messages;
determining that the set of messages is associated with at least one of the first data object or the first set of content comprised in the first data object; and
responsive to determining that the set of messages is associated with at least one of the first data object or the first set of content comprised in the first data object: storing the set of messages in association with the first data object.

3. The method of claim 1, wherein the set of messages is presented in a chat interface, and further comprising:
detecting an additional message exchanged via the chat interface while the first set of content is being displayed; and
responsive to detecting the additional message while the first set of content is being displayed, storing the additional message in association with the first data object.

4. The method of claim 3, wherein storing the additional message in association with the first data object is based on the additional message being received while the first data object is presented.

5. The method of claim 3, wherein storing the additional message in association with the first data object is based on a semantic analysis of a group of messages that includes the additional message to determine that the additional message relates to a first topic associated with the first data object.

6. The method of claim 3, wherein storing the additional message in association with the first data object is based on identifying a user interaction with the first data object and with the chat interface within a specified time window of receiving the additional message.

7. The method of claim 3, wherein storing the additional message in association with the first data object comprises: storing a link from the first data object to the additional message, wherein the additional message is stored in a message history separate from the first data object.

8. The method of claim 3, wherein storing the additional message in association with the first data object comprises: storing the additional message in a field of the first data object.

9. The method of claim 1, wherein the set of messages is presented in a chat interface, and further comprising:
detecting an additional message exchanged via the chat interface while the first set of content is being displayed;
determining that the additional message is not associated with the first data object; and
refraining from presenting the additional message in the chat interface while the first data object is being presented.

10. The method of claim 9, further comprising:
determining a second data object that is relevant to the additional message; and
storing the additional message in association with the second data object.

11. The method of claim 1, further comprising:
responsive to extracting and displaying a second set of content from a second data object in the GUI, determining that a second set of messages is stored in association with the second data object; and
based on (a) the second set of content from the second data object being displayed and (b) the second set of messages being stored in association with the second data object:
presenting the second set of messages concurrently with the second set of content from the second data object in the GUI.

12. The method of claim 10, further comprising:
responsive to determining that a second set of messages is stored in association with the second data object, presenting an interface element, in the GUI, representing a shortcut to the second set of messages; and
responsive to a user selection of the interface element, presenting the second set of messages in the GUI.

13. The method of claim 10, further comprising removing the first set of messages from the GUI when presenting the second set of messages in the GUI.

14. The method of claim 10, wherein a message in the first set of messages is stored in association with a plurality of data objects including the first data object.

15. The method of claim 1, further comprising:
determining that a message in the set of messages associated with the first data object is no longer relevant to the first data object; and
removing the association between the message and the first data object.

16. One or more non-transitory computer-readable media comprising instructions that, when executed by one or more hardware processors, cause performance of operations comprising:
accessing a first data object comprising a first set of content;
extracting and displaying the first set of content from the first data object in a Graphical User Interface (GUI);
determining that a set of messages is stored in association with the first data object; and
based on (a) the first set of content from the first data object being displayed and (b) the set of messages being stored in association with the first data object:
presenting the set of messages concurrently with the first set of content from the first data object in the GUI.

17. The one or more non-transitory computer-readable media of claim 16, wherein the operations further comprise:
prior to extracting and displaying the first set of content from the first data object:
detecting the set of messages;
determining that the set of messages is associated with at least one of the first data object or the first set of content comprised in the first data object; and
responsive to determining that the set of messages is associated with at least one of the first data object or the first set of content comprised in the first data object: storing the set of messages in association with the first data object.

18. The one or more non-transitory computer-readable media of claim 16, wherein the set of messages is presented in a chat interface and wherein the operations further comprise:
detecting an additional message exchanged via the chat interface while the first set of content is being displayed; and
responsive to detecting the additional message while the first set of content is being displayed, storing the additional message in association with the first data object.

19. A system comprising:
one or more hardware processors;
one or more non-transitory computer-readable media; and
program instructions stored on the one or more non-transitory computer-readable media that, when executed by the one or more hardware processors, cause the system to:
access a first data object comprising a first set of content;
extract and display the first set of content from the first data object in a Graphical User Interface (GUI);
determine that a set of messages is stored in association with the first data object; and
based on (a) the first set of content from the first data object being displayed and (b) the set of messages being stored in association with the first data object:
present the set of messages concurrently with the first set of content from the first data object in the GUI.

20. The system of claim 19, wherein the set of messages is presented in a chat interface and wherein the program instructions further cause the system to:
detect an additional message exchanged via the chat interface while the first set of content is being displayed; and
responsive to detecting the additional message while the first set of content is being displayed, store the additional message in association with the first data object.
